(19) United States
(12) Patent Application Publication
(10) Pub. No.: US 2003/0229499 A1
(43) Pub. Date: Dec. 11, 2003

(54) Voice-activated locking mechanism for securing firearms

(75) Inventors: Eric Von Bosse, Newburyport, MA (US); Joseph N. Kiesel, East Kingston, NH (US)

Correspondence Address: NIXON PEABODY, LLP, 8180 GREENSBORO DRIVE, SUITE 800, MCLEAN, VA, 22102, US

(73) Assignee: SIGARMS Inc., Exeter, NH

(21) Appl. No.: 10/167,217

(22) Filed: Jun. 11, 2002

(51) Int. Cl. G10L 21/00

(52) U.S. Cl. 704/275

(57) ABSTRACT

An improved locking mechanism for fire arms is activated through a comparison of a speech pattern with a voice print stored in memory to ensure only an authorized user can unlock the locking mechanism. The voice print and other parameters can be stored in memory or on a separate smart card.

### BACKGROUND OF THE INVENTION

I. Field of the Invention

The present invention relates to firearm security. More specifically, the present invention relates to a redundant voice-activated locking mechanism for securing a gun to prevent firing of the gun by unauthorized persons.

II. Discussion of the Prior Art

The Second Amendment of the U.S. Constitution guarantees that the “right of the people to keep and bear arms, shall not be infringed.” Those that choose to exercise this right assume the responsibility of ensuring that their weapons are secured and do not impose an unreasonable risk to the life, health and property of others. Since the Second Amendment was enacted in over 200 years ago, gun manufacturers have developed increasingly sophisticated technology to prevent firearms from being misused. Guns are routinely equipped with safeties to prevent misfiring. Various gun locks have also been developed to prevent children from firing the weapon. Locking gun cases have been developed not only to prevent children from gaining access to the weapon, but also to prevent theft of the weapon. Such locks and cases have typically been operated by a key or by entry of a secret combination.

Several problems exist with prior art gun locks and locking gun cases. First, the keys can be lost rendering the lock inoperable. Second, the keys can be found by children or others who can use the key to open the lock and gain access to the gun. Similarly, combinations for locks can be forgotten. Owners, therefore, often write down the combination. If a child learns the combination, the child will have unfettered access to the gun. further, such locks are only effective if they are used. If the gun lock or the gun case is left unlocked, the gun is not properly secured. Finally, mechanical locks can be easily picked by thieves or other criminals. They serve as a deterrent against theft but are not capable of preventing unauthorized persons from firing the gun.

In recent years, electronic locks have been developed. See, for example, U.S. Pat. No. 5,022,175 to Baker et al on Feb. 24, 1976. These typically include a solenoid that moves a safety between on and off positions, a memory for storing an access code, an input mechanism such as a keyboard for entering an access code, a comparator for comparing the entered code with the code stored in memory, control logic, and a battery. Often, the memory is a random access memory. If power is lost, the data stored in memory is lost causing the lock to become inoperable. Also, the access codes, typically a sequence of numbers, must be relatively short. Over time, an unauthorized person could determine what the access code is and use it to open the lock. Such mechanisms also do not prevent children who learn the code from gaining access to the weapon and provide no greater security than mechanical combination locks. Still another problem is that in an emergency situation when access to the gun is needed by the owner or an authorized person, that person may simply not remember the code.

More recently, various parties have developed locking arrangements that use voice technology to operate a lock or some other piece of security equipment. For example, U.S. Pat. No. 5,706,399 which issued to Bernard F. Bareis discloses a vehicle security alarm system which is controlled by speech. Various functions are accomplished using specific spoken commands. A microphone converts speech to time-variant voltage levels which are digitized using an analog-to-digital converter. A speech recognition subsystem monitors the digitized signals. When control words are recognized, output signals are generated. The output signals are employed to operate door locks, a siren or horn, vehicle lights, the vehicle's engine or the like. The speech recognition subsystem also has speaker verification capabilities. Specifically, voice template data is stored in a memory. As one speaks into the microphone, the speech characteristics are compared to the template data to verify that the command was spoken by an authorized user. Another speaker identification and verification system is described in U.S. Pat. No. 5,522,012 to Mammone et al dated May 28, 1996.

An application of voice recognition technology to firearm safety is discussed in U.S. Pat. No. 5,570,528 which issued to James W. Teetzel on Nov. 5, 1996. This patent describes a voice-activated locking apparatus that includes a locking mechanism which prevents activation of the weapon when the trigger is pulled. The locking mechanism includes a microphone connected to a voice recognition chip. The voice recognition chip evaluates the words spoken into the microphone to verify that the speech pattern of the voice corresponds to only that of an authorized user. If this evaluation indicates the words were spoken by an authorized user, the locking mechanism is unlocked and the gun can be fired if the trigger is pulled.

Several problems exist with the voice-activated weapon lock described in U.S. Pat. No. 5,570,528. First, the voice pattern of authorized users will vary depending upon levels of fatigue or stress. The system disclosed in the '528 patent does not account for this. Second, the system disclosed in the '528 patent does not address the possibility of voice duplication. High grade voice recording and playback equipment is readily available and a recording of an authorized user's voice could be used to activate the lock described in the '528 patent. Third, the '528 patent does not provide a system which automatically locks the gun if predetermined conditions exist for improved safety.

### SUMMARY OF THE INVENTION

An object of the present invention is to provide a firearms locking device which uses a voice print unique to an authorized user to actuate the locking device.

Another object of the present invention is to provide such a locking device which accounts for voice variations of the authorized user due to fatigue, stress, illness or other factors.

Still another object of the present invention is to provide such a locking device that is not susceptible to being opened by unauthorized personnel employing voice duplication technology.

A further object of the invention is to provide such a locking device having a second level of security which can be set and changed by an authorized user.

An additional object of the invention is to provide such a locking device which further includes automatic locking and unlocking features programmable by an authorized user.

Still a further object of the invention is to provide such a locking mechanism which includes non-volatile memory for storing voice prints, codes and logic parameters and a backup power source so that the locking mechanism can always be activated by an authorized user.

These and other objects are all achieved by providing a sophisticated locking mechanism that can either be coupled to a weapon to prevent firing of the weapon by unauthorized users or coupled to a case to prevent unauthorized access to the weapon itself. The locking mechanism will include a microprocessor for performing logic and control functions, non-volatile memory for storing voice prints, access codes and other parameters related to the operation of the locking mechanism. Main and backup power sources are provided to ensure the lock can be activated at any time. A microphone and analog-to-digital converter is also provided for entry of voice samples and commands. One or more data entry keys can also be provided.

The locking mechanism of the present invention creates a voice print using multiple samples which are averaged so that the locking mechanism can account for voice variations due to fatigue or stress. A separate authentication code is also required to activate the lock so that voice duplication, alone, will not be sufficient to activate the lock. Similarly, the locking mechanism includes a user selectable, time variable activation feature so that the locking mechanism automatically locks after a predetermined period of time. The locking mechanism can also be programmed to automatically lock if one or more selectable control words are picked up by the microphone.

### BRIEF DESCRIPTION OF THE DRAWINGS

FIG. 1 is a side view of a hand gun equipped with the locking mechanism of the present invention.

FIG. 2 is a block diagram of the locking mechanism of the present invention.

FIG. 3 is a flow chart showing the operation of the locking mechanism of the present invention.

FIG. 4 is a block diagram of an alternative embodiment of the present invention.

### DETAILED DESCRIPTION OF THE PREFERRED EMBODIMENTS

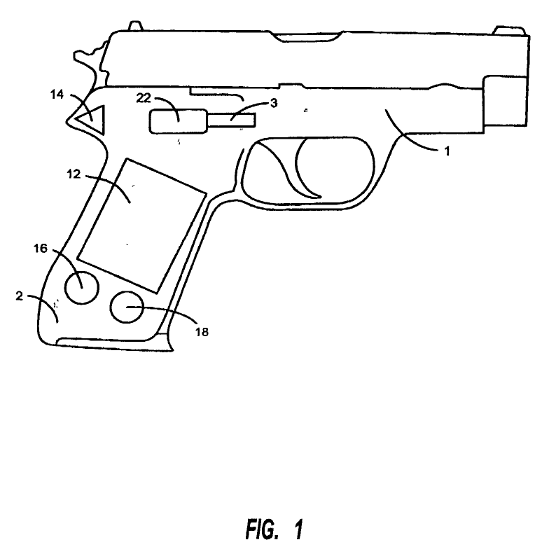

FIG. 1 shows a hand gun 1 equipped with the locking mechanism 10 of the present invention. The locking mechanism 10 includes an electronics package 12, a microphone 14, a pair of batteries 16 and 18 coupled to electronics package 12 by a switch 20, and a solenoid 22. The various components of the locking mechanism 10 are mounted within the handle 2 of the gun. The gun 1 has a safety 3 which is capable of being moved by a lock member, such as solenoid 22, between a lock position in which firing of the gun is precluded and an unlocked position in which the gun can be fired.

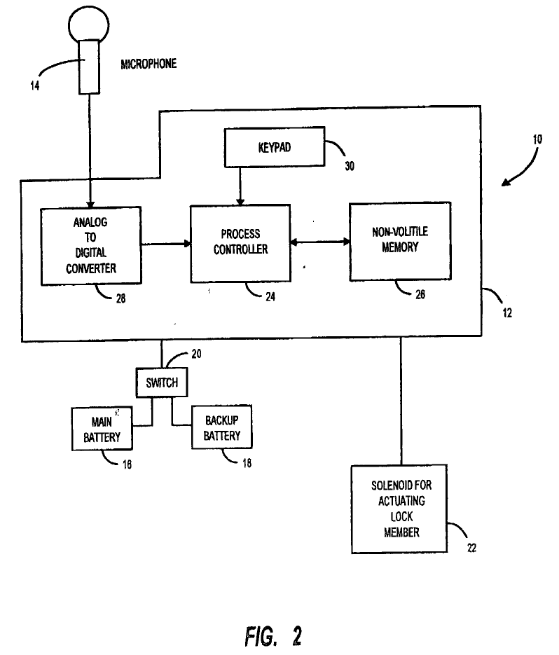

FIG. 2 is a block diagram of the locking mechanism 10. As shown, the electronics package 12 includes a process controller 24, which could be a microprocessor, for controlling the functions of the locking mechanism 10. The electronics package 12 also includes non-volatile memory 26 in which programmable parameters are stored. The type of non-volatile memory used can vary. It should be programmable and it should also not lose data stored therein if there is a disruption in power.

As shown in FIG. 2, the electronics package 12 also has an analog-to-digital converter 28. This A-D converter is used to digitize the signals generated by the microphone 14 so that these signals can be processed by the process controller. The electronics package 12 also has a key pad 30 that can be used for programming and operating the locking mechanism 10. While not shown, a small speaker or visual display, (such as one or more light emitting diodes) can be provided to convey information to a user of the gun 1.

The electronics package 12 is powered by a battery. In fact, two batteries 16 and 18 are provided. These are separately connectable to the electronics package 12 by the switch 20. Typically, the switch 20 will be set so the main battery 16 is electrically coupled to the electronics package 12. When the switch 20 is set in this position, there will be no discharge of power from the back-up battery. In the event the main battery 16 is fully discharged, a user can actuate the switch 20 to connect the back-up battery to the electronics package 12 so that the gun 1 and locking mechanism 10 remain usable until the user has an opportunity to charge or change the main battery 16. Because all of the programmable parameters of the locking mechanism are stored in the non-volatile member 12, there is no need to reprogram the locking mechanism even if the main battery 16 is fully discharged for an extended period of time. All the user needs to do is move the switch 20 to engage the back-up battery 18 to restore full functionality to the locking mechanism 10.

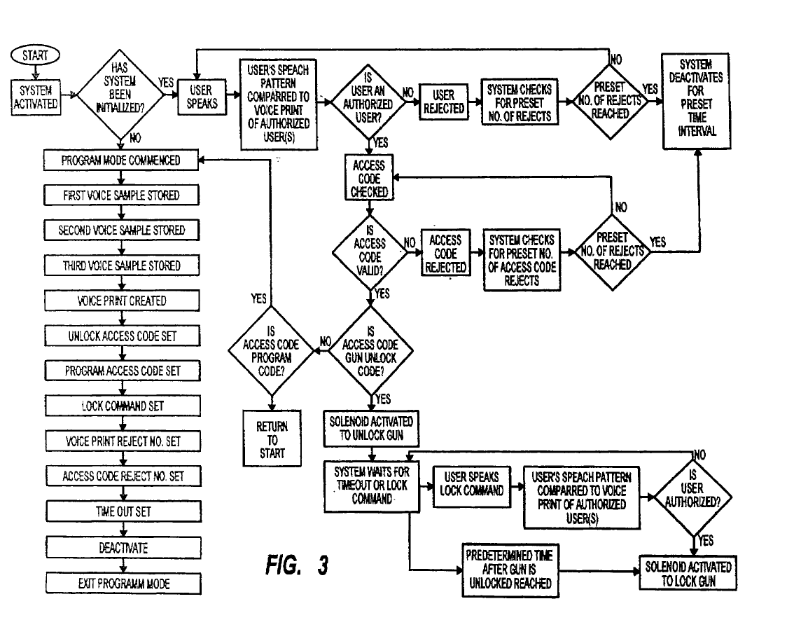

FIG. 3 is a flow chart which will be used to explain the manner in which locking mechanism 10 operates and the many advantages it offers. A user can activate the system by depressing a key on the key pad 30. The process controller 24, upon receipt of the signal indicating a key has been depressed, checks to see if the electronics package 12 has been programmed. If not, the process controller 24 automatically enters the program mode.

In the program mode, a number of parameters are set. These are all stored in the non-volatile memory 26. First, a plurality of voice samples are provided by the owner or other authorized user of the gun. The microphone and A-D converter are used to create digital electronic signals representative of each voice sample. These are processed by the process controller 24 and stored in memory 26. From these voice samples, a voice print is created. This voice print is also stored in memory 26. There are several reasons why multiple voice samples are used to create the voice print. One is to ensure greater accuracy. Another is so that the system can account for voice variations due to fatigue or stress of the authorized user. As discussed in greater detail below, the voice print is later compared to a user's speech pattern to determine whether the user is authorized to use the gun.

The present invention does not rely exclusively on voice pattern recognition to ensure that unauthorized users are unable to fire the gun. To operate the gun, the user must also enter a correct access code. Access codes can either be an alphanumeric code entered using the key pad 30 or a specific word spoken into the microphone 14. In the program mode, the user can set separate access codes later used to reenter the program mode or to actuate the solenoid 22 to unlock the gun. These codes are also stored in the non-volatile memory 26.

For added security, the system also can be programmed to deactivate the locking mechanism 10 for a set period of time if the user's voice does not match the voice print of an authorized user stored in memory or if the wrong access code is entered. In the program mode, the user can set the period of time during which the locking mechanism would be deactivated. The user can also set the number of invalid voice prints that are rejected before the system deactivates as well as the number of invalid access codes that are rejected before the system deactivates. These parameters, again, are stored in the non-volatile memory 26.

Still another safety feature of the present invention is the ability of the locking mechanism 10 to automatically lock the gun 1 if the gun has been unlocked for a predetermined period of time. The length of this period of time is also a programmable parameter which, again, is stored in the nonvolatile memory.

The system also is designed so that “lock” commands can be programmed and stored in the non-volatile memory. Typically, these will be a voice “lock” command that can be entered via the microphone 14 and also a “lock” command that can be entered using the keypad 30. If an unauthorized user has gained access to the gun and the gun is unlocked, the authorized user can speak the “lock” command code to relock the gun. This is an important safety feature, particularly if a criminal has successfully wrestled the gun away from the authorized user. If the authorized user has possession of the gun, he can lock it by either speaking a “lock” command or by entering a “lock” command using the keypad 30.

Once all of the above-described parameters are stored in memory, the system exits the program mode, the system has been initialized, and the gun is ready for safe use and storage. Upon subsequent receipt of a start signal by the process controller 24, the system will bypass the program mode unless the program access code is entered. Specifically, the process controller 24 will wait to receive a voice sample from the user via the microphone 14. Upon receipt of the voice sample, the controller 24 compares it with the voice print stored in memory 26. If there is no match, the system checks to see how many consecutive non-matches there have been. If the number of non-matches is less than the number set during the program phase, the processor waits for the next voice sample picked up by the microphone 14. If the number of non-matches equals the number set during the program phase, the controller deactivates the locking mechanism for the period of time set during the program phase.

As indicated above, even a successful match by the process controller 24 of the voice sample with the voice print stored in memory 26, will not be enough to unlock the gun 1. There must also be a match with an access code. Thus, after the voice sample and voice print match, the system compares the access code received (either via the keypad 30 or the microphone 14) with the access codes stored in memory 26 during programming. If the voice matches but the access code does not, the access code is rejected and the system checks to see if the number of successive unsuccessful access code entries is less than or equal to the programmed number of rejected access codes. So long as the number of successive unsuccessful access codes is less than the programmed number, the user can continue to try different access codes. As soon as the number of consecutive rejected access codes equals the programmed number, the locking mechanism will automatically deactivate for the predetermined period of time set during the program mode.

If there is a voice match and an access code match, the system determines whether the matched access code was the program access code or the unlock access code set in the program mode. If the program access code was entered, the system reenters the programming mode and the user can change any of the programmable parameters stored in memory. If, on the other hand, the unlock access code was entered, the solenoid 22 is actuated to unlock the safety 3 of the gun 1.

Once the safety 3 has been unlocked buy the solenoid 22, the controller 24 monitors signals from the microphone 14 and keypad 30. If a lock command is received either via the microphone 14 or keypad 30, the controller 24 sends a signal to the solenoid 22 causing it to relock the safety 3. In the event that the lock command is received via the microphone 14, the controller 24 compares the voice pattern of the person speaking the command with the voice print of the authorized user(s) stored in memory and only actuates the solenoid 22 to move the safety 3 into the locked position if the voice pattern of the speaker matches the voice print of an authorized user. Thus, an authorized user such as a police officer could issue the voice lock command and successfully disable the gun. Someone who is not an authorized user (such as a criminal) could not issue a lock command and disable the policeman's gun.

Not only will the controller 24 send a lock signal to the solenoid 22 if a lock command is received, but the controller 24 will also issue such a signal after a predetermined period of time after the safety 3 is unlocked. This provides additional security, the level of which is dependent upon the time-out parameter set in the program mode.

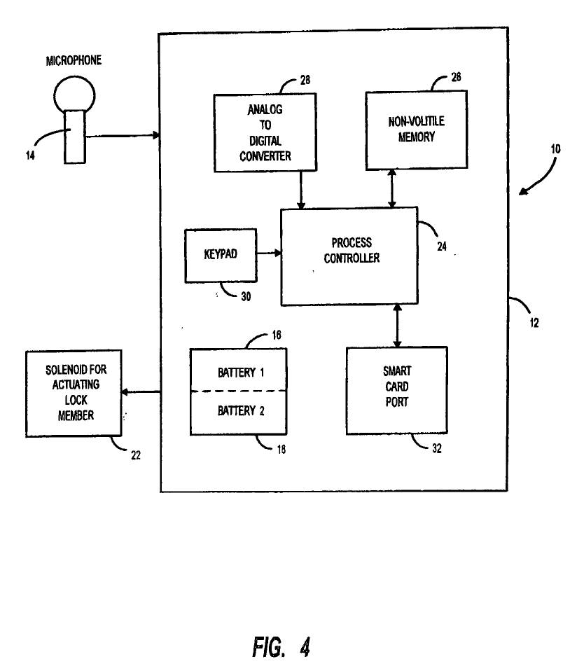

FIG. 4 is a block diagram showing an alternative embodiment of the present invention. As shown, the electronics locking mechanism 10 has an electronics package 12. The electronics package 12 consists of a process controller 24 which is coupled to both a non-volatile memory 26 and a smart card port 32 for data storage. The process controller receives inputs from two sources, the key pad 30 and the microphone 14 via the analog-to-digital converter 28. The electronics package is powered by batteries 16 and 18. The electronics package 12 controls the operation of a solenoid 22 (or some other suitable device) to actuate the safety of the gun.

A highly sophisticated voice recognition system is used by the locking mechanism 10 shown in FIG. 4 to ensure the gun cannot be used by unauthorized personnel or in an unintended manner. The voice recognition scheme utilized adopts a three-prong approach. First, the lock mechanism 10 will not operate unless there is a smart card coupled to the smart card port 32. The smart card acts as a key. Second, a voice print is created and stored on a smart card utilizing a predetermined number of voice samples. These voice samples are averaged for frequency range and volume to negate inflection variations due to stress. The voice print is used to identify an authorized user. Third, separate speech patterns (frequency patterns) are associated with access codes used to activate various specified safety functions. These frequency patterns are stored on the smart card. These functions include locking the fire arm, unlocking the firearm and initiating a time out interval at the end of which the firearm is locked. Once set up is complete, the voice recognition system not only requires a smart card coupled to the port 32, but also “listens” for the voice of an authorized user and also “listens” for specific words (frequency patterns) associated with an access code. Only when a smart card is in the port 32 and the voice of an authorized user delivers the specific words required to activate a feature of the locking mechanism will the process controller 24 deliver signals to the solenoid to lock or unlock the gun.

The locking mechanism 10 shown in FIG. 4 is also designed to accommodate initial set-up of the locking mechanism and alteration of that set-up to add or delete authorized users. Specifically, a master access code is stored in memory. This master access code is pre-set at the factory, cannot be changed, is required to enter the programming mode, and is unique to the locking mechanism of the gun. The key pad is used to enter this code to cause the locking mechanism to enter the program mode.

A principal difference between the embodiment shown in FIG. 2 versus the embodiment shown in FIG. 4 is that the embodiment shown in FIG. 4 employs the use of smart card technology. In the embodiment shown in FIG. 4, a smart card must be inserted into the firearm (i.e. coupled to the smart card port 32) to enable the firearm to function. When the smart card is removed, the controller 24 locks the safety and the firearm is rendered totally inoperable until the smart card is reinserted. The voice print used to identify an authorized user and the frequency patterns associated with the access codes can be stored on the smart card as opposed to the non-volatile memory 26. Each user can be given his or her own smart card. Thus, a user must insert his or her smart card into the gun and say the right words to activate a function of the locking mechanism.

If desired, the non-volatile memory of the locking mechanism can keep track of who has used the gun, how many shots were fired, and even the time and date each shot was fired. To provide this functionality, the process controller 24 can have a built-in clock. Either the microphone 14 of some other sensor can be used to detect the firing of a shot and send an appropriate signal to the controller. A code uniquely identifying the user can also be stored in the smart card.

The locking mechanism of the embodiment shown in FIG. 4 thus has three levels of safety: (1) if the smart card is not inserted, the locking mechanism will not operate; (2) if the voice print of the user does not correspond to the voice print stored on the smart card, the locking mechanism will not operate; and (3) if the user does not say the right word or combination of words, the locking mechanism will not perform the requested function. The smart card port 32 preferably has a compact, integral design and is located so the smart card can be inserted into the grip, grip plate, frame or magazine well of the gun and, thus, coupled to the port 32.

The analog-to-digital converter 28 converts the analog voice patterns generated by the microphone 14 to a digital signal. In the programming mode, the digital signal is sent to the process controller 24 to create and store on the smart card the voice pattern used in recognition of an authorized user. The controller 24 also uses the digital signals from the analog-to-digital converter 28 to create and store on the smart card the specific voice patterns to be associated with the event codes that, when matched, activate a function of the locking mechanism. In the operative mode, the microphone 14 and analog-to-digital converter 28 are used to transmit voice samples to the process controller 24. The process controller first compares these samples to the voice print stored on the smart card to see if there is a match between the user and the authorized user associated with the smart card. The process controller then compares these samples to the specific patterns stored on the smart card associated with the event codes that activate the various functions of the locking mechanism. Only if there is both a user match and an event code match will the controller 24 issue the instructions necessary to perform the function associated with the access code. When it is desirable to store information related to each shot fired, the microphone and analog-to-digital computer also send signals indicative of a fired shot to the controller 24.

The battery 16/18 associated with the locking mechanism of FIG. 4 has a low drain and compact design. Watch or calculator batteries could be used. Also, a “low power” indicator (not shown) can be provided to indicate when a battery charge is required.

The foregoing provides a description of a sophisticated locking mechanism. While it has been described for use on a handgun, the same locking mechanism can be adapted for use on rifles, shotguns and other weapons without deviating from the invention. This locking mechanism can also be used on gun cases.

Further, the locking mechanism of the present invention can easily be adapted to that there are multiple authorized users, each having their own voice prints stored in memory. All of the other parameters can be set differently for each different authorized user.

If so desired, the system can also be adapted to store information regarding which authorized user unlocked the gun, when each user unlocked the gun, the number of shots fired when the gun was unlocked, and other data related to gun operation. To accomplish this, one would add a simple clock chip (unless there was already a clock associated with the controller). This data could be transmitted to a display for later viewing.

The foregoing is presented to describe a preferred embodiment of the present invention and various alternatives and enhancements that could be made. Those skilled in the art will recognize that various other changes and modifications can be made without departing from the invention. Thus, the foregoing description is not intended to be limiting and the scope of the invention is defined by the claims.

What is claimed:

1. A locking apparatus for a weapon, said locking apparatus comprising:
a. an electronics package having a process controller, non-volatile memory for storing at least one voice print based upon a plurality of voice samples and at least one access code, an analog-to-digital converter, a keypad, and a power switch;
b. first and second batteries separately connectable to said electronics package via said switch;
c. a microphone coupled to said electronics package; and
d. a locking member movable between a locked position and an unlocked position and controlled by said electronics package such that said locking member only moves from said locked position to said unlocked position if the microphone receives a voice pattern that matches the voice print and a code matching an access code stored in memory is also entered.

2. A locking apparatus for a weapon, said locking apparatus comprising:
a. an electronics package having a process controller, a non-volatile memory, an analog-to-digital converter, and a smart card port;
b. at least one battery;
c. a microphone coupled to said electronics package;
d. a smart card selectively coupled to said smart card port for storing a voice print associated with an authorized user based upon a plurality of voice samples a plurality of voice samples and a voice pattern associated with an access code;
e. a locking member movable between a locked position and an unlocked position and controlled by said electronics package such that the locking member moves from said locked position to said unlocked position if (i) a smart card is coupled to the smart card port; and (ii) the process controller receives, via the microphone and analog-to-digital converter, signals that correspond both to the voice print stored on the smart card and associated with an authorized user and the voice pattern stored on the smart card and associated with an access code.

3. The locking apparatus of claim 2 wherein each authorized user is assigned a smart card on which a voice print associated with the specific authorized user is stored and a voice pattern associated with an access code is stored.

4. The locking apparatus of claim 1 wherein said process controller stores in said non-volatile memory the date and time of each firing of the gun.

5. The locking apparatus of claim 4 wherein a code uniquely identifying a user associated with the smart card is stored on the smart card.

6. The locking mechanism of claim 5 wherein said code is stored in non-volatile memory along with the date and time of each firing of the gun.
